(19) United States
(12) Patent Application Publication
(10) Pub. No.: US 2024/0191089 A1
(43) Pub. Date: Jun. 13, 2024

(54) INKS FOR 3D PRINTING HAVING HIGH MODULUS AND DISPERSION STABILITY

(71) Applicant: 3D Systems, Inc., Rock Hill, SC (US)

(72) Inventors: Mehrgan KHAVARI, Corvallis, OR (US); Khalil MOUSSA, Chapel Hill, NC (US)

(21) Appl. No.: 18/532,480

(22) Filed: Dec. 7, 2023

Related U.S. Application Data
(60) Provisional application No. 63/431,474, filed on Dec. 9, 2022.

(51) Int. Cl. C09D 11/30; B33Y 40/20; B33Y 70/10; C09D 4/06; C09D 7/40; C09D 7/61

(52) U.S. Cl. CPC C09D 11/30; B33Y 40/20; B33Y 70/10; C09D 4/06; C09D 7/61; C09D 7/67

(57) ABSTRACT

In one aspect, inks for use with a three-dimensional (3D) printing system are described herein. In some embodiments, a composite ink described herein comprises a carrier ink comprising a curable material and a solid powder filler dispersed in the carrier ink. In some cases, the composite ink, in an uncured state, has a highly accelerated life testing (HALT) score of at least 2 when tested at 65° C. for at least 14 days. Additionally, in some embodiments, the composite ink, in an uncured state, has an average loss factor tan δ of less than or equal to 3 or less than or equal to 2 over an angular frequency range of 0.5 to 5 rad/s.

### CROSS REFERENCE TO RELATED APPLICATIONS

This application claims priority pursuant to 35 U.S.C. § 119 to U.S. Provisional Patent Application No. 63/431,474, filed Dec. 9, 2022, which is hereby incorporated by reference in its entirety.

### FIELD

The present application generally relates to inks for use with additive manufacturing or three-dimensional (3D) printing systems and, more particularly, to composite inks comprising a carrier ink and a filler dispersed in the carrier ink.

### BACKGROUND

Some commercially available 3D printers or additive manufacturing systems, such as the ProJet® 3D printers manufactured by 3D Systems of Rock Hill, South Carolina, use inks, which are also known as build materials, that are jetted through a print head as a liquid to form various 3D objects, articles, or parts. Other 3D printing systems also use an ink that is jetted through a print head or otherwise dispensed onto a substrate. In some instances, the ink is solid at ambient temperatures and converts to liquid at elevated jetting temperatures. In other instances, the ink is liquid at ambient temperatures. Moreover, in some cases, the ink can be cured following dispensing and/or deposition of the ink onto the substrate. Curing can be achieved using a laser or other source of electromagnetic radiation.

Other 3D printers form 3D articles from a reservoir, vat, or container of a fluid ink or build material or a powdered ink or build material. In some cases, a binder material or a laser or other source is used to selectively solidify or consolidate layers of the ink or build material in a stepwise fashion to provide the 3D article.

Some inks used in additive manufacturing generally require high modulus materials for some applications, for example wind tunnel modeling and low-warp applications. Composite inks can provide some desirable properties for certain applications. However, as will be appreciated, some composite inks or other inks exhibit processing and handling limitations, including relatively low dispersion stability in some instances.

Therefore, there exists a need for improved inks for 3D printing that have mechanical properties in the cured state suitable for certain applications and also have high dispersion stability in the uncured or liquid state, while having other properties suitable for use in one or more 3D printing processes and systems, such as stereolithography (SLA) processes and systems and Figure 4® processes and systems provided by 3D Systems, Inc.

### SUMMARY

In one aspect, inks for use with an additive manufacturing or 3D printing system are described herein, which, in some embodiments, may offer one or more advantages over prior inks, particularly composite inks comprising solid fillers. For example, in some cases, an ink described herein is a well-dispersed and shelf-life stable ink that easily re-disperses when needed. Additionally, in some embodiments, an ink described herein can be completely free-radical polymerized and/or does not polymerize using a cationic polymerization pathway. It is further to be understood that an ink described herein, in some instances, in either the uncured state or the cured state, can have one or more structural or performance properties that provide an advantage for use of the ink in additive manufacturing or 3D printing. For example, in some cases, an ink described herein has a viscosity suitable for additive manufacturing and also provides printed 3D articles having a high modulus.

In some embodiments, an ink or composite ink for use in a 3D printing system described herein comprises a carrier ink comprising a curable material and a solid powder filler dispersed in the carrier ink. Additionally, in some cases, the composite ink, in an uncured state, has a highly accelerated life testing (HALT) score of at least 2 when tested at 65° C. for at least 14 days, and/or the composite ink, in an uncured state, has an average loss factor tan δ of less than or equal to 3 or less than or equal to 2 over an angular frequency range of 0.5 to 5 rad/s. Additional components and features of inks are described further below.

In another aspect, methods of forming a 3D article by additive manufacturing are described herein. In some embodiments, such a method comprises selectively depositing layers of an ink described herein in a fluid state onto a substrate to form the three-dimensional article. The method can further comprise photocuring the ink. Additionally, in some embodiments of a method described herein, the ink is selectively photocured according to preselected computer aided design (CAD) parameters or other parameters from a digital file representing or corresponding to the 3D article.

Alternatively, in other embodiments, a method of forming a 3D article by additive manufacturing comprises retaining an ink described herein in a fluid state in a container, and selectively applying energy to the ink in the container to solidify at least a portion of a first fluid layer of the ink, thereby forming a first solidified layer that defines a first cross-section of the article. The method further comprises raising or lowering the first solidified layer to provide a second fluid layer of the ink at a surface of the fluid ink in the container, and selectively applying energy to the ink in the container to solidify at least a portion of the second fluid layer of the ink, thereby forming a second solidified layer that defines a second cross-section of the article, the first cross-section and the second cross-section being bonded to one another in a z-direction. As described further herein, the foregoing steps may be repeated any desired number of times needed to complete the 3D article. Moreover, in some preferred embodiments, selectively applying energy to the ink in the container comprises photocuring the ink.

In still another aspect, printed 3D articles are described herein. Such an article can be formed from any ink and using any method described herein.

These and other embodiments are described in greater detail in the detailed description which follows.

### BRIEF DESCRIPTION OF THE DRAWINGS

The following figures are not necessarily drawn to scale and are provided for illustrative purposes and to aid understanding of the present disclosure.

FIG. 1 illustrates a perspective view of a component of a HALT score testing apparatus.

FIG. 2 illustrates a perspective view of the component of FIG. 1 on its side, orthogonal to the position of the component as illustrated in FIG. 1.

FIG. 3 illustrates a graph of HALT scoring categories.

FIG. 4 illustrates a perspective view of a component similar to the component of FIG. 1 on its side, analogous to the component illustrated in FIG. 2.

FIG. 5 illustrates a plot of the storage modulus (G′) and the loss modulus (G″) as a function of angular frequency (rad/s) for a composite ink according to one embodiment described herein.

### DETAILED DESCRIPTION

Embodiments described herein can be understood more readily by reference to the following detailed description, figures, and examples. Elements, apparatus and methods described herein, however, are not limited to the specific embodiments presented in the detailed description, figures, and examples. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9. Similarly, a stated range of “1 to 10” should be considered to include any and all subranges beginning with a minimum value of 1 or more and ending with a maximum value of 10 or less, e.g., 1 to 5, or 4 to 10, or 3 to 7, or 5 to 8.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity (that is, the amount is non-zero). For example, a material present in an amount “up to” a specified amount can be present from a detectable (non-zero) amount and up to and including the specified amount.

Additionally, unless the context clearly requires otherwise, the use of the singular article “a” or “an” is to be understood to refer to “one or more” or “at least one.”

The terms “three-dimensional printing system,” “three-dimensional printer,” “printing,” and the like generally describe various solid freeform fabrication techniques for making three-dimensional articles or objects by stereolithography (SLA), selective deposition, jetting, fused deposition modeling (FDM), multi-jet modeling (MJM), and other additive manufacturing techniques now known in the art or that may be known in the future that use a build material or ink to fabricate three-dimensional objects.

### I. Inks for 3D Printing

In one aspect of the present disclosure, composite inks for use in a 3D printing system or method are provided. In some embodiments, a composite ink described herein comprises a carrier ink comprising a curable material, and a solid powder filler dispersed in the carrier ink. In some cases, the composite ink may further comprise one or more additional components, such as one or more photoinitiators, polymerization inhibitors or stabilizers, colorants, dispersants, antifoaming or deaeration agents (also called deaerators), or a combination of two or more of the foregoing. Individual components of composite inks will be further described below.

Notably, composite inks of the present disclosure can have compositions providing high stability and ease of use in 3D printing. For example, in some cases, a composite ink described herein, in an uncured state, has a highly accelerated life testing (HALT) score of at least 2 when tested at 65° C. for at least 14 days. In some instances, the composite ink has a HALT score of 3 when tested at 65° C. for at least 14 days. HALT scores are described further hereinbelow in Example 1.

Additionally, in some embodiments, a composite ink described herein, in an uncured state, has an average loss factor tan δ of less than or equal to 3 or less than or equal to 2 over an angular frequency range of 0.5 to 5 rad/s. For reference purposes herein, “tan δ” refers to the tangent of 8, which is equal to G″/G′. As understood by one of ordinary skill in the art, G′ is the storage modulus (also known as the elastic modulus), and G″ is the loss modulus (also known as the viscous modulus) of the composite ink, as a function of angular frequency, as described further herein and as calculated in ASTM D4440-15 (Standard Test Method for Plastics: Dynamic Mechanical Properties Melt Rheology). As understood by a person of ordinary skill in the art, G″ and G′ are derived from the phase shift between the oscillatory stress versus strain. The strain is applied and the stress is measured (e.g., with a torque sensor). The parameters tan δ, G″, and G′ are further described in AN004 (“Viscosity and dynamic mechanical testing”) by A. Franck, TA Instruments. According to some embodiments, compositional parameters of a composite ink described herein are selected to provide a small or minimal loss factor tan δ (as described herein), and, as understood by one of ordinary skill in the art, the loss factor 8 is considered a structural feature of the composite ink.

Both the HALT score and the loss factor tan δ are related to the dispersion stability of a composite ink described herein. In some embodiments, a composite ink described herein can have both a HALT score described herein and also a loss factor tan δ described herein. Alternatively, in other cases, a composite ink can have only a HALT score described herein or only a loss factor tan δ described herein, while the other parameter (HALT score or loss factor tan δ) is outside a range described herein. Moreover, in some embodiments, a composite ink described herein, in an uncured state, can include particles that have good dispersion within the composite ink and can be shelf-life stable, such that the particles in the composite ink can be easily re-dispersed through agitation, if re-dispersion is needed.

Further, a composite ink in an “uncured” state, as used throughout the present disclosure, comprises an ink that includes a curable material or polymerizable component that has not been cured, i.e., polymerized and/or cross-linked, or that has been cured (polymerized and/or cross-linked to a minimal or negligible degree). For instance, in some cases, an uncured ink is no more than about 1% polymerized or cross-linked, or no more than about 0.5% or no more than about 0.1% polymerized or cross-linked. The degree of polymerization or cross-linking can be determined using any protocol or method not inconsistent with the technical objectives of the present disclosure, such as by determining the percentage of monomers incorporated into a polymer network (e.g., based on molecular weight of the polymer compared to the molecular weight of the monomer, or based on the total polymer mass compared to the theoretical maximum of the total polymer mass) or by determining the amount of unincorporated monomers. When more than one method is used to determine a degree of polymerization or cross-linking, the results of the methods can be averaged to obtain a percentage described herein. It is further to be understood that the degree of polymerization or cross-linking described herein is different than “degree of polymerization” defined as the number of repeating units in a polymer molecule.

In addition, a composite ink described herein, in some embodiments, has certain flow characteristics that provide one or more advantages for 3D printing. For example, in some cases, a composite ink described herein is not a Bingham fluid at 30° C. (in an uncured state). Moreover, in some instances, a composite ink described herein (in an uncured state) has a shear viscosity of no greater than 5000 cps at 30° C., based on a shear rate of 1.0 (1/s), when measured in accordance with the shear rate sweep procedure of Example 3. In some cases, a composite ink described herein has a shear viscosity of no greater than 3000 cps or no greater than 2000 cps at 30° C., based on a shear rate of 1.0 (1/s), when measured in accordance with the shear rate sweep procedure of Example 3. In some implementations, a composite ink described herein has a shear viscosity of 500-1500 cps at 30° C., based on a shear rate of 1.0 (1/s), when measured in accordance with the shear rate sweep procedure of Example 3.

Thus, in some cases, a composite ink described herein, including in an uncured state, can have one or more structural parameters that overcome certain use limitations of some other materials for 3D printing. For instance, in some cases, composite inks or build materials according to the present disclosure can overcome limitations such as limited particle dispersion stability (which can limit shelf life), high viscosity (which can limit use in pumping and leveling requirements in 3D printers), and/or uncontrolled cure behavior associated with cationic polymerization chemistry (which can limit printing resolution).

Turning now in more detail to specific components of composite inks described herein, a composite ink according to the present disclosure can include various components in various amounts. It is to be understood that the total amount of all components of a composite ink described herein, in general, is 100 wt. % of the composite ink, in a given instance. Likewise, it is to be understood that all components of a carrier ink described herein total to 100 wt. % of the carrier ink, in a given instance.

As one component, composite inks described herein comprise a carrier ink, and the carrier ink comprises a curable material. The carrier ink may also be referred to as a base ink. Any curable material not inconsistent with the objectives of the present disclosure may be used in a carrier or base ink described herein. For example, in some embodiments, the curable material of the carrier ink comprises one or more monomeric curable materials and/or one or more oligomeric curable materials. Additionally, in some instances, the curable material of the carrier ink comprises a combination of one or more monomeric curable materials and one or more oligomeric curable materials.

A curable material, for reference purposes herein, comprises a chemical species that includes one or more curable or polymerizable moieties. A “polymerizable moiety,” for reference purposes herein, comprises a moiety that can be polymerized or cured to provide a printed 3D article or object. Such polymerizing or curing can be carried out in any manner not inconsistent with the objectives of the present disclosure. In some embodiments, for example, polymerizing or curing comprises irradiating a polymerizable or curable material with electromagnetic radiation having sufficient energy to initiate a polymerization or cross-linking reaction. For instance, in some cases, ultraviolet (UV) radiation can be used. Thus, in some instances, a polymerizable moiety comprises a photo-polymerizable or photo-curable moiety, such as a UV-polymerizable moiety. In some embodiments, a curable material described herein is photo-polymerizable or photo-curable at wavelengths ranging from about 300 nm to about 400 nm or from about 320 nm to about 380 nm. Alternatively, in other instances, a curable material is photo-polymerizable at visible wavelengths of the electromagnetic spectrum.

Moreover, a polymerization reaction, in some cases, comprises a free radical polymerization reaction, such as that between points of unsaturation, including points of ethyleneic unsaturation, in which carbon-carbon double bonds are present. Other polymerization reactions may also be used. As understood by one of ordinary skill in the art, a polymerization reaction used to polymerize or cure a curable material described herein can comprise a reaction of a plurality of “monomers” or chemical species having one or more functional groups or moieties that can react with one another to form one or more covalent bonds.

One non-limiting example of a polymerizable moiety of a curable material described herein is an ethylenically unsaturated moiety, such as a vinyl moiety, allyl moiety, or (meth)acrylate moiety, where the term “(meth)acrylate” throughout this disclosure includes acrylate or methacrylate or a mixture or combination thereof.

“Oligomeric” species, which are contained in the oligomeric curable material described herein, are themselves polymers or oligomers and have a relatively high molecular weight or a relatively high viscosity. These species are also capable of undergoing additional polymerization, such as through one or more points of unsaturation described herein. A population of oligomeric species in the oligomeric curable material described herein can have varying molecular structures and/or formulas throughout the population (such as may be exhibited, for example, by a specified mass of a urethane acrylate having a non-unity molecular weight distribution, or by a specified mass of an ethoxylated polyethylene glycol having a distribution of ethylene glycol units and/or a distribution of ethoxy units within the population). The weight average molecular weight of an oligomeric curable material described herein is generally in the range from about 500 to 6,000. Additionally, in some cases, the oligomeric curable material of an ink described herein comprises one or more ethylenically unsaturated species having a dynamic viscosity of 125,000 to 250,000 cP at 50° C., when measured according to ASTM D2983. In some preferred embodiments, the oligomeric curable material comprises one or more ethylenically unsaturated species having a dynamic viscosity of 150,000 to 200,000 cP at 50° C., when measured according to ASTM D2983. Not intending to be bound by theory, it is believed that such a combination of molecular weight and viscosity contributes to the achievement of the inventive technical effects of inks described herein, when an oligomeric curable material is used.

In contrast to an “oligomeric” species, “monomeric” species, which are contained in the monomeric curable material described herein, are not themselves a polymer or oligomer, and have a relatively low molecular weight or a relatively low viscosity. “Monomeric” species contained in a monomeric curable material can have a consistent or well-defined molecular structure and/or formula throughout the population (such as may be exhibited, for instance, by a specified mass of ethoxylated (4) bisphenol A diacrylate or a specific mass of the above-described curable monomer). Additionally, in some embodiments, a monomeric curable material as described herein has a viscosity of 500 centipoise (cP) or less at 25° C., when measured according to ASTM D2983, and/or a molecular weight of less than 500, less than 400, or less than 300.

Additionally, an oligomeric curable material and/or a monomeric curable material described herein can comprise a monofunctional, difunctional, trifunctional, tetrafunctional, pentafunctional, or higher functional curable species. A “monofunctional” curable species, for reference purposes herein, comprises a chemical species that includes one curable or polymerizable moiety. Similarly, a “difunctional” curable species comprises a chemical species that includes two curable or polymerizable moieties; a “trifunctional” curable species comprises a chemical species that includes three curable or polymerizable moieties; a “tetrafunctional” curable species comprises a chemical species that includes four curable or polymerizable moieties; and a “pentafunctional” curable species comprises a chemical species that includes five curable or polymerizable moieties. Thus, in some embodiments, a monofunctional curable material of an ink described herein comprises a mono(meth)acrylate, a difunctional curable material of an ink described herein comprises a di(meth)acrylate, a trifunctional curable material of an ink described herein comprises a tri(meth)acrylate, a tetrafunctional curable material of an ink described herein comprises a tetra(meth)acrylate, and a pentafunctional curable material of an ink described herein comprises a penta(meth)acrylate. Other monofunctional, difunctional, trifunctional, tetrafunctional, and pentafunctional curable materials may also be used.

Moreover, for the avoidance of doubt, a monofunctional, difunctional, trifunctional, tetrafunctional, and pentafunctional curable material, in some cases, can comprise a relatively low molecular weight species, i.e., a monomeric species, or a relatively high molecular weight species, i.e., an oligomeric species.

In general, any oligomeric curable material or combination of oligomeric curable materials not inconsistent with the objectives of the present disclosure may be used in an ink described herein. In some cases, an oligomeric curable material comprises a polyester (meth)acrylate oligomer, a urethane (meth)acrylate oligomer, or an epoxy(meth)acrylate oligomer. Further, in some embodiments, an oligomeric curable material described herein comprises an aliphatic polyester urethane acrylate oligomer and/or an acrylate amine oligomeric resin, such as EBECRYL 7100. In some cases, an oligomeric curable material described herein comprises a polypropylene glycol mono(meth)acrylate or polyethylene glycol mono(meth)acrylate. In some embodiments, an oligomeric curable material comprises a monofunctional aliphatic urethane (meth)acrylate. Moreover, in some cases, an oligomeric curable material comprises a diacrylate and/or dimethacrylate ester of an aliphatic, cycloaliphatic or aromatic diol, including polyethylene glycol, ethoxylated or propoxylated neopentyl glycol, ethoxylated or propoxylated bisphenol A, ethoxylated or propoxylated bisphenol F, ethoxylated or propoxylated bisphenol S, ethoxylated or propoxylated 1,1,1-trimethylolpropanetri(meth)acrylate, or ethoxylated or propoxylated glycerol tri(meth)acrylate. An oligomeric material may also comprise a cycloaliphatic epoxy.

Some non-limiting examples of commercially available oligomeric curable materials useful in some embodiments described herein include the following: alkoxylated tetrahydrofurfuryl acrylate, commercially available from SARTOMER under the trade name SR 611; monofunctional urethane acrylate, commercially available from RAHN USA under the trade name GENOMER 1122; an aliphatic urethane diacrylate, commercially available from ALLNEX under the trade name EBECRYL 8402; a multifunctional acrylate oligomer, commercially available from DYMAX Corporation/BOMAR under the trade name BR-952; aliphatic polyether urethane acrylate, commercially available from DYMAX Corporation/BOMAR under the trade name BR-371S; low molecular weight, difunctional, aliphatic polyether urethane methacrylate commercially available from BOMAR/DYMAX under the trade name BR-371MS; low molecular weight, difunctional aliphatic polyester urethane acrylate commercially available from BOMAR/DYMAX under the trade name BR-741; a difunctional aliphatic polyether urethane methacrylate commercially available from BOMAR/DYMAX under the trade name BR-541 MB; a difunctional aliphatic polyester urethane acrylate commercially available from BOMAR/DYMAX under the trade name BR-771F; a low viscosity, difunctional, aliphatic urethane acrylate commercially available from BOMAR/DYMAX under the trade name BR-970H; a low molecular weight, difunctional, aliphatic polyester urethane methacrylate commercially available from BOMAR/DYMAX under the trade name XR-741MS; and difunctional methacrylate oligomers commercially available from ESSTECH Inc. under the trade names EXOTHANE-4, EXOTHANE-8, and EXOTHANE-10. Other commercially available oligomeric curable materials may also be used.

Urethane (meth)acrylates suitable for use in inks described herein, in some cases, can be prepared in a known manner, typically by reacting a hydroxyl-terminated urethane with acrylic acid or methacrylic acid to give the corresponding urethane (meth)acrylate, or by reacting an isocyanate-terminated prepolymer with hydroxyalkyl acrylates or methacrylates to give the urethane (meth)acrylate. Suitable processes are disclosed, inter alia, in EP-A 114 982 and EP-A 133 908. The weight average molecular weight of such (meth)acrylate oligomers, in some cases, can be from about 500 to 6,000. Urethane (meth)acrylates are also commercially available from SARTOMER under the product names CN980, CN981, CN975 and CN2901, or from BOMAR Specialties Co. under the product name BR-741.

An oligomeric curable material, when used, can be present in a carrier ink described herein in any amount not inconsistent with the objectives of the present disclosure. In some cases, the oligomeric curable material, in total, is present in the carrier ink in an amount of 15-85 wt. %, based on the total weight of the carrier ink.

In addition, any monomeric curable material or combination of monomeric curable materials not inconsistent with the objectives of the present disclosure may be used as a monomeric curable material component of a carrier ink described herein. In some cases, a monomeric curable material of a carrier ink described herein comprises one or more species of (meth)acrylates, such as one or more monofunctional, difunctional, trifunctional, tetrafunctional (meth)acrylates, and/or pentafunctional (meth)acrylates. In some embodiments, for instance, a monomeric curable material comprises methyl (meth)acrylate, ethyl (meth)acrylate, n-propyl (meth)acrylate, n-butyl (meth)acrylate, isobutyl (meth)acrylate, n-hexyl (meth)acrylate, 2-ethylhexyl (meth)acrylate, n-octyl (meth)acrylate, n-decyl (meth)acrylate, n-dodecyl (meth)acrylate, 2-hydroxyethyl (meth)acrylate, 2- or 3-hydroxypropyl (meth)acrylate, 2-methoxyethyl (meth)acrylate, 2-ethoxyethyl (meth)acrylate, 2- or 3-ethoxypropyl (meth)acrylate, tetrahydrofurfuryl methacrylate, isobornyl (meth)acrylate, 2-(2-ethoxyethoxy)ethyl acrylate, cyclohexyl methacrylate, 2-phenoxyethyl acrylate, glycidyl acrylate, isodecyl acrylate, 2-phenoxyethyl (meth)acrylate, lauryl methacrylate, or a combination thereof. In some embodiments, a monomeric curable material comprises one or more of allyl acrylate, allyl methacrylate, triethylene glycol di(meth)acrylate, tricyclodecane dimethanol diacrylate, and cyclohexane dimethanol diacrylate. Additionally, in some cases, a monomeric curable material comprises diacrylate and/or dimethacrylate esters of aliphatic, cycloaliphatic or aromatic diols, including 1,3- or 1,4-butanediol, neopentyl glycol, 1,6-hexanediol, diethylene glycol, triethylene glycol, tetraethylene glycol, tripropylene glycol, 1,4-dihydroxymethylcyclohexane, 2,2-bis(4-hydroxycyclohexyl)propane or bis(4-hydroxycyclohexyl)methane, hydroquinone, 4,4′-dihydroxybiphenyl, bisphenol A, bisphenol F, or bisphenol S. A monomeric curable material described herein may also comprise 1,1-trimethylolpropane tri(meth)acrylate, pentaerythritol monohydroxy tri(meth)acrylate, dipentaerythritol monohydroxy penta(meth)acrylate, and/or bis(trimethylolpropane) tetra(meth)acrylate. In some cases, a monomeric curable material comprises an epoxy.

Additional non-limiting examples of commercially available monomeric curable materials useful in some embodiments described herein include the following: isobornyl acrylate (IBOA), commercially available from SARTOMER under the trade name SR 506; isobornyl methacrylate, commercially available from SARTOMER under the trade name SR 423A; triethylene glycol diacrylate, commercially available from SARTOMER under the trade name SR 272; triethylene glycol dimethacrylate, commercially available from SARTOMER under the trade name SR 205; tricyclodecane dimethanol diacrylate, commercially available from SARTOMER under the trade name SR 833S; tris(2-hydroxy ethyl)isocyanurate triacrylate, commercially available from SARTOMER under the trade name SR 368; 2-phenoxyethyl acrylate, commercially available from SARTOMER under the trade name SR 339; ethoxylated (3 mole) bisphenol A diacrylate, commercially available from SARTOMER under the trade name SR 349; a cyclic monofunctional acrylate, commercially available by RAHN USA Corp. under the trade name GENOMER 1120; dipentaerythritol pentaacrylate, commercially available from SARTOMER under the trade name SR 399 LV; hydroxyethyl acrylamide; morpholine acrylamide; a cyclic or multicyclic carbonate (meth)acrylate; isocyanurate triallyl, commercially available from SARTOMER under the trade name SR533; vinyl methyl oxazolidinone, commercially available from BASF under the trade name VMOX; and acetoacetate ethyl methacrylate. Other commercially available monomeric curable materials may also be used.

A monomeric curable material, when used, can be present in a carrier ink described herein in any amount not inconsistent with the objectives of the present disclosure. In some cases, the monomeric curable material component, in total, is present in the carrier ink in an amount of 15-85 wt. %, based on the total weight of the carrier ink.

As described above, the curable material of a carrier ink described herein can comprise various monomeric and/or oligomeric curable materials. For example, in some preferred embodiments, the curable material of the carrier ink comprises one or more acrylate, methacrylate, or vinyl species. In other cases, the curable material of the carrier ink comprises one or more epoxy species. Additionally, in some preferred embodiments, all or substantially all of the curable material of the carrier ink is curable by free-radical polymerization. For instance, in some implementations, at least 90 wt. %, at least 95 wt. %, or at least 99 wt. % of the curable material of the carrier ink is curable by free-radical polymerization. The use of free-radical polymerization (as opposed to other types of polymerization) can in some cases provide one or more advantages for 3D printing.

The carrier ink of a composite ink described herein, in some embodiments, also comprises a photoinitiator component. The photoinitiator component can be operable to initiate polymerization or curing of the curable material component of the carrier ink (e.g., by free-radical polymerization) upon exposure to light of the proper wavelength. Any photoinitiator not inconsistent with the objectives of the present disclosure may be used in a carrier ink described herein. In some embodiments, a photoinitiator comprises an alpha-cleavage type (unimolecular decomposition process) photoinitiator or a hydrogen abstraction photosensitizer-tertiary amine synergist, operable to absorb light preferably between about 250 nm and about 420 nm or between about 300 nm and about 385 nm, to yield free radical(s).

Examples of alpha cleavage photoinitiators are Irgacure 184 (CAS 947-19-3), Irgacure 369 (CAS 119313-12-1), and Irgacure 819 (CAS 162881-26-7) or Omnirad 819. An example of a photosensitizer-amine combination is Darocur BP (CAS 119-61-9) with diethylaminoethylmethacrylate.

In addition, in some instances, suitable photoinitiators comprise benzoins, including benzoin, benzoin ethers, such as benzoin methyl ether, benzoin ethyl ether and benzoin isopropyl ether, benzoin phenyl ether and benzoin acetate, acetophenones, including acetophenone, 2,2-dimethoxyacetophenone and 1,1-dichloroacetophenone, benzil, benzil ketals, such as benzil dimethyl ketal and benzil diethyl ketal, anthraquinones, including 2-methylanthraquinone, 2-ethylanthraquinone, 2-tert-butylanthraquinone, 1-chloroanthraquinone and 2-amylanthraquinone, triphenylphosphine, benzoylphosphine oxides, for example 2,4,6-trimethylbenzoyldiphenylphosphine oxide (Lucirin TPO), benzophenones, such as benzophenone and 4,4′-bis(N,N′-dimethylamino)benzophenone, thioxanthones and xanthones, acridine derivatives, phenazine derivatives, quinoxaline derivatives or 1-phenyl-1,2-propanedione, 2-O-benzoyl oxime, 1-aminophenyl ketones or 1-hydroxyphenyl ketones, such as 1-hydroxycyclohexyl phenyl ketone, phenyl 1-hydroxyisopropyl ketone and 4-isopropylphenyl 1-hydroxyisopropyl ketone.

Suitable photoinitiators can also comprise those operable for use with a HeCd laser radiation source, including acetophenones, 2,2-dialkoxybenzophenones and 1-hydroxyphenyl ketones, such as 1-hydroxycyclohexyl phenyl ketone or 2-hydroxyisopropyl phenyl ketone (=2-hydroxy-2,2-dimethylacetophenone). Additionally, in some cases, suitable photoinitiators comprise those operable for use with an Ar laser radiation source including benzil ketals, such as benzil dimethyl ketal. In some embodiments, a photoinitiator comprises an α-hydroxyphenyl ketone, benzil dimethyl ketal or 2,4,6-trimethylbenzoyldiphenylphosphine oxide or a mixture thereof.

Another class of suitable photoinitiators, in some instances, comprises ionic dye-counter ion compounds capable of absorbing actinic radiation and generating free radicals for polymerization initiation. In some embodiments, carrier inks containing ionic dye-counter ion compounds can be polymerized upon exposure to visible light within the adjustable wavelength range of about 400 nm to about 700 nm. Ionic dye-counter ion compounds and their mode of operation are disclosed in EP-A-0 223 587 and U.S. Pat. Nos. 4,751,102; 4,772,530; and 4,772,541.

A photoinitiator can be present in a carrier ink described herein in any amount not inconsistent with the objectives of the present disclosure. In some embodiments, a photoinitiator is present in a carrier ink in an amount of up to about 5 wt. %, up to about 4 wt. %, or up to about 3 wt. %, based on the total weight of the ink. In some cases, a photoinitiator is present in an amount of about 0.1-5 wt. %, 0.1-4 wt. %, 0.1-3.5 wt. %, 0.1-2 wt. %, 0.5-5 wt. %, 0.5-4 wt. %, 0.5-3.5 wt. %, 1-5 wt. %, 1-4 wt. %, 1-3.5 wt. %, 2-5 wt. %, or 2-4 wt. %, based on the total weight of the carrier ink.

It is further to be understood that the amounts (weight percents) described in the immediately preceding paragraph refer to photoinitiators that are non-oligomeric and non-polymeric. That is, the amounts described above refer to “monomeric” or “molecular” photoinitiators, which may, for instance, have a molecular weight of less than 400. However, it is also to be understood that oligomeric or polymeric photoinitiators may be used in inks and methods described herein. But in such an instance (when an oligomeric or polymeric photoinitiator is used), then the amounts (weight percents) above are to be calculated without taking into account the weight of the oligomeric or polymeric portion or moiety of the oligomeric or polymeric photoinitiator. In other words, to determine the overall amount (weight percent) of the oligomeric or polymeric photoinitiator that is present in the ink, the calculation (specifically, the numerator) should be based on only the molecular weight of the photoactive moiety of the photoinitiator, not on the molecular weight(s) of the remaining moieties or repeating units of the oligomeric or polymeric photoinitiator (for purposes of the present disclosure).

Turning to possible additional components of carrier inks described herein, carrier inks described herein can further comprise one or more photosensitizers in some cases. In general, such a sensitizer can be added to a carrier ink to increase the effectiveness of one or more photoinitiators that may also be present. In some instances, a sensitizer comprises isopropylthioxanthone (ITX) or 2-chlorothioxanthone (CTX).

A sensitizer can be present in a carrier ink in any amount not inconsistent with the objectives of the present disclosure. In some embodiments, a sensitizer is present in an amount ranging from about 0.1 wt. % to about 2 wt. % or from about 0.5 wt. % to about 1 wt. %, based on the total weight of the carrier ink. However, in other cases, a carrier ink (or composite ink) described herein excludes a sensitizer such as described above.

Moreover, carrier inks described herein, in some embodiments, further comprise one or more polymerization inhibitors and/or stabilizing agents. A polymerization inhibitor can be added to an ink to provide additional thermal stability to the composition. Any polymerization inhibitor not inconsistent with the objectives of the present disclosure may be used. Moreover, a polymerization inhibitor can retard or decrease the rate of polymerization, and/or prevent polymerization from occurring for some period of time or “induction time” until the polymerization inhibitor is consumed. Further, in some cases, a polymerization inhibitor described herein is an “addition type” inhibitor. An inhibitor described herein can also be a “chain transfer type” inhibitor. In some instances, a suitable polymerization inhibitor comprises methoxyhydroquinone (MEHQ). In some cases, an inhibitor is commercially available from BASF of Florham Park, New Jersey under the TINUVIN® trade-designation.

A stabilizing agent, in some embodiments, comprises one or more anti-oxidants. A stabilizing agent can comprise any anti-oxidant not inconsistent with the objectives of the present disclosure. In some cases, suitable anti-oxidants include various aryl compounds, including butylated hydroxytoluene (BHT), which can also be used as a polymerization inhibitor in some embodiments described herein. More generally, a single species may serve as both a stabilizing agent and a polymerization inhibitor. It is also possible, in some cases, to use a plurality of inhibitors and/or stabilizing agents, wherein differing inhibitors and/or stabilizers provide differing effects and/or work synergistically.

A polymerization inhibitor and/or a stabilizing agent can be present in a carrier ink in any amount not inconsistent with the objectives of the present disclosure. In some embodiments, a polymerization inhibitor is present in an amount ranging from about 0.01 wt. % to about 2 wt. % or from about 0.05 wt. % to about 1 wt. %, based on the total weight of the carrier ink. Similarly, in some cases, a stabilizing agent is present in a carrier ink in an amount ranging from about 0.1 wt. % to about 5 wt. %, from about 0.5 wt. % to about 4 wt. %, or from about 1 wt. % to about 3 wt. %, based on the total weight of the carrier ink. It should also be noted that, in some cases, a stabilizer described herein can be added to a composite ink after combining a carrier or base ink with the solid powder filler component to form the composite ink.

Turning to another possible component of a carrier ink described herein, carrier inks described herein can also comprise at least one colorant. Such a colorant of a carrier ink described herein can be a particulate colorant, such as a particulate pigment, or a molecular colorant, such as a molecular dye. Any such particulate or molecular colorant not inconsistent with the objectives of the present disclosure may be used. In some cases, for instance, the colorant of an ink comprises an inorganic pigment, such as TiO₂ and/or ZnO. In some embodiments, the colorant of a carrier ink comprises a colorant for use in a RGB, SRGB, CMY, CMYK, L*a*b*, or Pantone® colorization scheme. Moreover, in some cases, a particulate colorant described herein has an average particle size of less than about 5 μm, or less than about 1 μm. In some instances, a particulate colorant described herein has an average particle size of less than about 500 nm, such as an average particle size of less than about 400 nm, less than about 300 nm, less than about 250 nm, less than about 200 nm, or less than about 150 nm. In some instances, a particulate colorant has an average particle size of about 50-5000 nm, about 50-1000 nm, or about 50-500 nm. It is also possible for a colorant described herein to comprise an organic species, such as an organic small molecule dye. Such a dye, in some cases, is a violet dye, a blue dye, a green dye, a yellow dye, an orange dye, or a red dye. For example, a coumarin, fluorescein, or curcumin may be used in some instances.

A colorant can be present in a carrier ink described herein in any amount not inconsistent with the objectives of the present disclosure. In some cases, colorant is present in the carrier ink in an amount up to about 2 wt. %, or an amount of about 0.005-2 wt. %, 0.01-2 wt. %, 0.01-1.5 wt. %, 0.01-1 wt. %, 0.01-0.5 wt. %, 0.1-2 wt. %, 0.1-1 wt. %, 0.1-0.5 wt. %, or 0.5-1.5 wt. %, based on the total weight of the carrier ink. It is also to be noted that, in some instances, a colorant can be added to a composite ink described herein after the carrier ink and solid powder filler have been combined to form the composite ink, rather than the colorant being considered part of the carrier ink. Likewise for some other optional components of a carrier ink described herein.

In some embodiments, a carrier ink described herein may contain one or more viscosity modifying agents. Non-limiting examples of viscosity modifying agents include a saturated fatty acid or a combination of saturated fatty acids, or an oil, such as a plant oil. The carrier inks described herein may comprise up to 5 wt. %, up to 3 wt. %, up to 1 wt. %, up to 0.5 wt. %, or up to 0.1 wt. % of a viscosity modifying agent, based on the total weight of the carrier ink.

Further, in some embodiments, a carrier ink of a composite ink described herein has a shear viscosity of no greater than 200 cps, no greater than 150 cps, no greater than 100 cps, or no greater than 50 cps at 30° C., based on a shear rate of 1.0 (1/s), when measured in accordance with the shear rate sweep procedure of Example 2.

The carrier ink component of a composite ink described herein can be present in the composite ink in any amount not inconsistent with the technical objectives of the present disclosure. In some cases, the carrier ink is present in an amount of 10-80 wt. %, based on the total weight of the composite ink. In some preferred embodiments, the carrier ink is present in an amount of 25-55 wt. % or 30-45 wt. %, based on the total weight of the composite ink.

Composite inks described herein also comprise a solid powder filler dispersed in the carrier ink of the composite ink. Any solid powder filler not inconsistent with the objectives of the present disclosure may be used. Such a filler, in general, can be non-curable, such that the filler does not participate chemically as a reactant in a polymerization reaction used to form a polymer network during additive manufacturing. Such a filler can also be used to impart one or more desirable properties to the ink (such as color, mechanical strength, or electrical conductivity). Non-limiting examples of fillers include inorganic fillers such as ceramic, metal, or other particles, and organic fillers such as discrete organic polymer particles. In some cases, the solid powder filler comprises or is formed from zirconia (ZrO₂), yttria (Y₂O₃), magnesia (MgO), or another oxide.

In some preferred embodiments, the solid powder filler comprises or is formed from alumina (Al₂O₃) or silica (SiO₂). In some especially preferred embodiments, the solid powder filler comprises a SiO₂ powder. Any SiO₂ powder not inconsistent with the technical objectives of the present disclosure may be used. In some cases, for instance, the solid powder filler comprises amorphous SiO₂. Additionally, in some implementations, the solid powder filler comprises or is formed from a combination of two or more oxides, including two or more of the specific oxides described above. For example, in some instances, the solid powder filler comprises or is formed from a combination of alumina and silica such as an aluminosilicate; a combination of zirconia and yttria such as an yttria-stabilized zirconia (YSZ); or a combination of alumina, zirconia, and magnesia such as an alumina doped with zirconia and magnesia. Other combinations are also possible.

Moreover, the solid powder filler can have various sizes and/or shapes. In some preferred embodiments, the solid powder filler of a composite ink described herein has an average or median particle size (D50) of 0.1 μm to 5 μm (or greater than 0.1 μm and up to and including 5 μm). The average or median particle size (D50) can be measured in any manner not inconsistent with the objectives of the present disclosure. In particular, the foregoing particle size can be measured using laser diffraction, such as using a laser particle size analyzer from HORIBA. It is also possible to use dynamic image analysis according to ISO 13322-2. More specifically, size analysis can be carried out using a HORIBA LA-960 particle size analyzer, and the LA-960 can be equipped with an LY-9610 or LA-9610 Dynamic Imaging accessory. In some cases, the solid powder filler has an average or median particle size (D50) of 0.1 μm to 2 μm or 0.1 μm to 1 μm. In some especially preferred embodiments, the solid powder filler has an average or median particle size (D50) of 0.1 μm to 0.5 μm. Moreover, in some instances, the solid powder filler component of a composite ink descried herein is free or substantially free of very small or nano-sized particles. For example, in some preferred embodiments, the composite ink comprises no or substantially no solid powder filler having a particle size of less than 100 nm (e.g., less than 1 wt. %, less than 0.5 wt. %, less than 0.1 wt. %, or less than 0.01 wt. % SiO₂ particles having a particle size of less than 100 nm, where the weight percent is based on the total weight of the composite ink). In some instances, the solid powder filler of a composite ink described herein has a particle size distribution spanning 0.1 μm to 10 μm or 0.1 μm to 5 μm, where at least 98 wt. %, at least 99 wt. %, or at least 99.9 wt. % of solid powder filler particles have a size within this range. Moreover, in some embodiments, the particle size distribution is monomodal and Gaussian, as opposed to being bimodal or otherwise polymodal or non-Gaussian. It is to be understood that the sizes described above can refer to average sizes in three dimensions (e.g., corresponding to equivalent spherical diameter).

Moreover, in some cases, the solid powder filler has a uniform size and/or a uniform shape. The particles of solid powder filler can also have a smooth surface texture. In some embodiments, for example, the solid powder filler has an average particle aspect ratio of 1 to 1.1. As understood by one of ordinary skill in the art, the aspect ratio of a population of particles (such as a population of solid powder filler particles described herein) can be measured by inspection of images of the particles, such as scanning electron microscope (SEM), transmission electron microscope (TEM), or other microscopy images. Additionally, in some instances, the solid powder filler comprises no or substantially no irregularly shaped particles (e.g., less than 1 wt. %, less than 0.5 wt. %, less than 0.1 wt. %, or less than 0.01 wt. % particles having an irregular shape or shape that differs from the shape of the remainder of the solid powder filler particles, where the weight percent is based on the total weight of the composite ink). For reference purposes herein, an irregularly shaped particle can be a particle that is non-spherical or non-spheroid, or that is dendritic, or that is elongated and has an aspect ratio greater than 3.

Further, in some embodiments described herein, a solid powder filler described herein has a relatively low total surface area, even though the average or median particle size of the powder may be smaller than some other powders having a higher total surface area. Not intending to be bound by theory, it is believed that excluding or substantially excluding very small particles can provide one or more advantages to a composite powder described herein. In some cases, the solid powder filler component of a composite ink described herein has an average Brunauer-Emmett-Teller (BET) specific surface area of less than 30 m²/g, less than 20 m²/g, or less than 10 m²/g, according to multipoint or single-point BET measurements based on adsorption of dinitrogen (N2) gas. In some instances, the solid powder filler component of a composite ink described herein has an average BET specific surface area of 3 to 30 m²/g, 3 to 20 m²/g, or 3 to 15 m²/g. Moreover, in some particularly preferred embodiments, the solid powder filler has an average particle size of 0.1 μm to 1 μm or 0.1 to 5 μm, and also an average BET specific surface area of less than 30 m²/g, less than 20 m²/g, or less than 10 m²/g, or 3-30 m²/gwhen measured as described herein. In some instances, the solid powder filler has an average or median particle size (D50) of about 0.3 μm to 0.7 μm and a specific surface area of about 3 m²/g to 15 m²/g. Table 1 below shows some non-limiting example combinations of average particle size and BET specific surface area for some exemplary embodiments described herein (e.g., for amorphous silica particles).

TABLE 1
Some Possible Combinations of Particle
Size and Specific Surface Area.

| Particle Size (D50, μm) | Specific Surface Area (BET, m²/g) |
|---|---|
| 1.5 | 3-5 |
| 1 | 3-6 |
| 0.5 | 4-7 |
| 0.3 | 15 |
| 0.1 | 20-30 |

In addition, in some cases, particles of a solid powder filler component described herein are functionalized. For example, in some instances, the solid powder filler has a functionalized exterior surface. Various functionalization may be included in a solid powder filler described herein. In general, the functionalization described herein imparts or provides a chemical functional group on the surface of the solid powder filler particles that is different than the functional groups that are “native” or naturally occurring on the surface of the particle, based on its primary chemical composition (e.g., the “functionalization” provides functional groups that differ from the functional groups (such as —OH groups) that might be present on the surface of an SiO₂ or Al₂O₃ particle). In some preferred embodiments, the exterior surface of the solid powder filler is functionalized with (meth)acrylate moieties. In some cases, the exterior surface of the solid powder filler is functionalized with phenyl, vinyl, or isocyanate moieties. Other functional groups may also be used.

Any amount or degree of surface functionalization not inconsistent with the technical objectives of the present disclosure may be used. Moreover, the amount or degree of surface functionalization can be described as a weight percent based on the total filler weight or as moles per unit area of the filler. For example, in some cases, a solid powder filler described herein can be functionalized with up to 5 wt. % surface functional group species, based on the total weight of the filler, such as an amount of 1 to 2 wt. % surface functionalization group species. In some instances, as a further example, 0.1 to 5 wt. %, 0.1 to 3 wt. %, 0.1 to 1 wt. %, 0.5 to 5 wt. %, 0.5 to 3 wt. %, 1 to 5 wt. %, 1 to 3 wt. %, or 1 to 2 wt. % silane (meth)acrylate is used to provide (meth)acrylate functionalization to the surface of the solid powder filler, where the weight percent of silane (meth)acrylate (the surface functional group species in this instance) is based on the total weight of the filler as the denominator. That is, the weight percent is calculated based on weight of silane (meth)acrylate divided by total weight of filler, multiplied by 100% to obtain a weight percent. Moreover, in some embodiments, the amount of surface functional group is 1 to 100, 1 to 50, 1 to 30, 1 to 20, 1 to 15, or 1 to 10 micromoles of functional group per square meter of the solid powder filler (μmoles/m²). That is (using (meth)acrylate surface functionalization as an example), for every 1 m² of surface area of the solid powder filler, there can be 1-100, 1-50, 1-30, 1-20, 1-15, or 1-10 micromoles of (meth)acrylate functional group. In some preferred embodiments, the amount is 1-20 or 1-10 μmoles/m².

The solid powder filler component of a composite ink described herein can be present in the composite ink in any amount not inconsistent with the technical objectives of the present disclosure. In some cases, the solid powder filler is present in an amount of 20-85 wt. %, based on the total weight of the composite ink. In some implementations, the solid powder filler is present in an amount of 45-70 wt. % or 55-65 wt. %, based on the total weight of the composite ink. Moreover, in some embodiments, the solid powder filler is present in an amount of 10-75 volume percent (v. %), based on the total volume of the composite ink. In some implementations, the solid powder filler is present in an amount of 25-55 v. % or 38-48 v. %, based on the total volume of the composite ink.

A composite ink described herein, in some cases, may comprise one or more additional components, in addition to the carrier ink (including the various components of the carrier ink, as described herein) and in addition to the solid powder filler. In some embodiments, for example, the composite ink further comprises a dispersant. The dispersant may, in particular, be a dispersant for the solid powder filler particles, assisting with dispersion of the solid powder filler within the carrier ink. Any dispersant not inconsistent with the technical objectives of the present disclosure may be used. In some embodiments, a dispersant described herein comprises a first functional group that has affinity for or binds to the surface of a solid powder filler described herein (e.g., a silica particle), as well as a separate and distinct second functional group that has affinity for or binds to a species of the carrier ink or that interacts with the carrier ink as a whole in a manner that promotes dispersion of the solid powder filler within the carrier ink, as opposed to agglomeration or precipitation of the solid powder filler particles. In some instances, the dispersant has one or more siloxane groups (the first functional group) and one or more hydrophobic “tails” (e.g., an aromatic or aliphatic hydrocarbyl moiety having 4 to 4000 carbon atoms). In other instances, the dispersant has one or more acidic moieties, such as one or more carboxylic acid (—COOH) moieties or other Bronsted-Lowry or Lewis acid functional groups (as the first functional group). Such a dispersant can be especially useful for use with a solid filler powder having basic moieties or functional groups on the surface, such as hydroxyl (—OH) moieties, amine (—NH₂) moieties, or other Bronsted-Lowry or Lewis base functional groups. Similarly, in other cases, the dispersant can have one or more basic moieties or functional groups as the first functional group, which may be particularly useful in some embodiments for use with solid powder filler particles having acidic moieties or functional groups on the surface. More generally, in some cases, the dispersant in a particular instance can be selected based on its inclusion of a chemical moiety or functional group that reacts with, has an affinity for, or otherwise binds to or associates with a chemical moiety or functional group on the surface of the solid powder filler particles of the composite ink. Non-limiting examples of dispersants include Lubrizol Solsperse X300, 39000, 41000, 71000, 79000, and 85000; and BYK Disperbyk 111 and Disperbyk 180. Other dispersants may also be used.

The dispersant of a composite ink, if present at all, can be present in any amount not inconsistent with the technical objectives of the present disclosure. In some preferred embodiments, the dispersant (when present) is present in an amount of 0.2-5 wt. % compared to the amount of solid powder filler.

A composite ink described herein, in some cases, may further comprise an anti-foaming or deaeration agent, and such a species (if present), may be present in an amount of up to about 5 wt. %, based on the total weight of the composite ink.

Composite inks described herein can also exhibit a variety of desirable properties, in addition to those described hereinabove, in a cured state. An ink in a “cured” state, as used throughout the present disclosure, comprises an ink that includes a curable material or polymerizable component that has been at least partially cured, i.e., at least partially polymerized and/or cross-linked. For instance, in some cases, a cured ink is at least about 70% polymerized or cross-linked or at least about 80% polymerized or cross-linked. In some embodiments, a cured ink is at least about 85%, at least about 90%, at least about 95%, at least about 98%, or at least 99% polymerized or cross-linked. In some instances, a cured ink is between about 80% and about 99% polymerized or cross-linked. As stated above, the degree of polymerization or cross-linking of an ink can be determined using any protocol or method not inconsistent with the technical objectives of the present disclosure, such as by determining the percentage of monomers incorporated into a polymer network (e.g., based on molecular weight of the polymer compared to the molecular weight of the monomer, or based on the total polymer mass compared to the theoretical maximum of the total polymer mass) or by determining the amount of unincorporated monomers. When more than one method is used to determine a degree of polymerization or cross-linking, the results of the methods can be averaged to obtain a percentage described herein. It is further to be understood that the degree of polymerization or cross-linking described herein is different than “degree of polymerization” defined as the number of repeating units in a polymer molecule.

In some cases, a composite ink described herein, in a cured state (or a printed 3D article formed therefrom), can have one or more advantages compared to some other inks or composite inks, particularly (meth)acrylate containing inks. For example, in some instances, a composite ink described herein in a cured state (or an article formed therefrom) has a high flexural and/or elastic modulus, such as a flexural modulus of 8500-11,500 MPa, when measured according to ASTM D790, and/or an elastic modulus of 9000-12,000 MPa, when measured according to ASTM D638 Type IV. Additionally, in some embodiments, a composite ink described herein, when cured, has a high tensile strength and/or flexural strength, such as a tensile strength of 50-90 MPa or 70-90 MPa, when measured according to ASTM D638 Type IV, and/or a flexural strength of 70-150 MPa or 90-150 MPa, when measured according to ASTM D790. In some instances, a composite ink described herein, when cured, has an elongation at break of 0.7-2% or 0.7-1.8%, when measured according to ASTM D638 Type IV. Moreover, in some cases, a composite ink described herein, when cured, can exhibit a plurality of the properties described in the present disclosure. For example, in some instances, a composite ink described herein, in a cured state, has at least two, at least three, or at least four of the following: (1) a flexural modulus within a range described above, (2) an elastic modulus within a range described above, (3) a tensile strength within a range described above, (4) a flexural strength within a range described above, and (5) an elongation at break within a range described above.

Inks and composite inks described herein can be produced in any manner not inconsistent with the objectives of the present disclosure. In some embodiments, for instance, a method for the preparation of an ink described herein comprises the steps of mixing the components of the ink, melting the mixture, and filtering the molten mixture. Melting the mixture, in some cases, is carried out at a temperature of about 75° C. or in a range from about 75° C. to about 85° C. In some embodiments, an ink described herein is produced by placing all components of the ink in a reaction vessel and heating the resulting mixture to a temperature ranging from about 75° C. to about 85° C. with stirring. The heating and stirring are continued until the mixture attains a substantially homogenized molten state. In general, the molten mixture can be filtered while in a flowable state to remove any large undesirable particles (where it is understood that the solid powder filler particles, when present, are not removed by a filtering step). The filtered mixture can then be cooled to ambient temperatures and stored until ready for use in a 3D printing system. It is also possible to prepare an ink described herein (such as a carrier ink or base ink) as described above, and then, following filtration, to add the solid powder filler particles to the carrier or base ink, with stirring, mixing, rolling, or agitation to disperse the solid powder filler particles in the carrier or base ink, without further filtration subsequent to this mixing step.

### II. Methods of Forming a 3D Article

In another aspect, methods of forming or “printing” a 3D article or object by additive manufacturing are described herein. Methods of forming a 3D article or object described herein can include forming the 3D article from a plurality of layers of an ink described herein in a layer-by-layer manner (such as in MJP or SLA printing methods). For example, in some instances, an MJP method of printing a 3D article comprises selectively depositing layers of a composite ink described herein in a fluid state onto a substrate, such as a build pad of a 3D printing system. The method can further comprise further curing (e.g., photocuring) the ink. Moreover, curing can comprise polymerizing one or more polymerizable moieties or functional groups of one or more components of the ink. In some cases, a layer of deposited ink is cured prior to the deposition of another or adjacent layer of ink. Additionally, curing one or more layers of deposited ink, in some embodiments, is carried out by exposing the one or more layers to electromagnetic radiation, such as ultraviolet (UV) light, visible light, or infrared light, as described above. In addition, in some embodiments, such a method further comprises supporting at least one of the layers of the ink with a support material, before or after curing. Any support material not inconsistent with the objectives of the present disclosure may be used, as described further below.

Alternatively, a method of printing a 3D article comprises retaining an ink (e.g., a composite ink described hereinabove in Section I) in a fluid state in a container; selectively applying energy to the ink in the container to solidify at least a portion of a first fluid layer of the ink, thereby forming a first solidified layer that defines a first cross-section of the article; raising or lowering the first solidified layer to provide a second fluid layer of the ink at a surface of the fluid ink in the container; and selectively applying energy to the ink in the container to solidify at least a portion of the second fluid layer of the ink, thereby forming a second solidified layer that defines a second cross-section of the article, the first cross-section and the second cross-section being bonded to one another in a z-direction. Moreover, in some such embodiments, selectively applying energy to the ink in the container comprises photocuring the ink. Further, such a method can be carried out, in some cases, using photocuring only or primarily using photocuring, and without using thermal curing or cationic curing of a polymerizable moiety or curable material described herein (e.g., using less than 10%, less than 5%, or less than 1% thermal curing or cationic curing, where the percentage is based on the mole percent of cured moieties, as described above).

Further, in some embodiments of methods described herein, one or more layers of an ink described herein has a thickness of about 10 μm to about 100 μm, about 10 μm to about 80 μm, about 10 μm to about 50 μm, about 20 μm to about 100 μm, about 20 μm to about 80 μm, or about 20 μm to about 40 μm. Other thicknesses are also possible.

Methods of forming a 3D article by additive manufacturing can also include forming the object in a manner other than a layer-by-layer manner.

Additionally, any ink described hereinabove in Section I may be used in a method described herein. For example, in some cases, an ink used in a method described herein comprises a composite ink comprising 30-45 wt. % carrier ink and 45-70 wt. % solid powder filler dispersed in the carrier ink, based on the total weight of the composite ink.

Further details regarding various methods, including “material deposition” methods (such as MJP) or “vat polymerization” methods (such as SLA), are provided below.

### A. Material Deposition Methods

In a material deposition method, one or more layers of an ink described herein are selectively deposited onto a substrate and cured. Curing of the ink may occur after selective deposition of one layer, each layer, several layers, or all layers of the ink.

In some instances, an ink described herein is selectively deposited in a fluid state onto a substrate, such as a build pad of a 3D printing system. Selective deposition may include, for example, depositing the ink according to preselected CAD parameters. For example, in some embodiments, a CAD file drawing corresponding to a desired 3D article to be printed is generated and sliced into a sufficient number of horizontal slices. Then, the ink is selectively deposited, layer by layer, according to the horizontal slices of the CAD file drawing (or other digital representation of the desired 3D article) to print the desired 3D article. A “sufficient” number of horizontal slices is the number necessary for successful printing of the desired 3D article, e.g., to produce it accurately and precisely.

Further, in some embodiments, a preselected amount of ink described herein is heated to the appropriate temperature and jetted through a print head or a plurality of print heads of a suitable inkjet printer to form a layer on a print pad in a print chamber. In some cases, each layer of ink is deposited according to preselected CAD parameters (or other digital parameters corresponding to the desired article). A suitable print head to deposit the ink, in some embodiments, is a piezoelectric print head. Additional suitable print heads for the deposition of ink and support material described herein are commercially available from a variety of ink jet printing apparatus manufacturers. For example, Xerox, Hewlett Packard, or Ricoh print heads may be used in some instances.

Additionally, in some embodiments, an ink described herein remains substantially fluid upon deposition. Alternatively, in other instances, the ink exhibits a phase change upon deposition and/or solidifies upon deposition. Moreover, in some cases, the temperature of the printing environment can be controlled so that the jetted droplets of ink solidify on contact with the receiving surface. In other embodiments, the jetted droplets of ink do not solidify on contact with the receiving surface, remaining in a substantially fluid state. Additionally, in some instances, after each layer is deposited, the deposited material is planarized and cured with electromagnetic (e.g., UV, visible, or infrared light) radiation prior to the deposition of the next layer. Optionally, several layers can be deposited before planarization and curing, or multiple layers can be deposited and cured followed by one or more layers being deposited and then planarized without curing. Planarization corrects the thickness of one or more layers prior to curing the material by evening the dispensed material to remove excess material and create a uniformly smooth exposed or flat up-facing surface on the support platform of the printer. In some embodiments, planarization is accomplished with a wiper device, such as a roller, which may be counter-rotating in one or more printing directions but not counter-rotating in one or more other printing directions. In some cases, the wiper device comprises a roller and a wiper that removes excess material from the roller. Further, in some instances, the wiper device is heated. It should be noted that the consistency of the jetted ink described herein prior to curing, in some embodiments, should desirably be sufficient to retain its shape and not be subject to excessive viscous drag from the planarizer.

Moreover, a support material, when used, can be deposited in a manner consistent with that described hereinabove for the ink. The support material, for example, can be deposited according to the preselected CAD parameters (or other digital parameters) such that the support material is adjacent or continuous with one or more layers of the ink. Jetted droplets of the support material, in some embodiments, solidify or freeze on contact with the receiving surface. In some cases, the deposited support material is also subjected to planarization, curing, or planarization and curing. Any support material not inconsistent with the objectives of the present disclosure may be used.

Layered deposition of the ink and support material can be repeated until the 3D article has been formed. In some embodiments, a method of printing a 3D article further comprises removing the support material from the ink.

Curing of the ink may occur after selective deposition of one layer of ink, of each layer of ink, of several layers of ink, or of all layers of the ink necessary to print the desired 3D article. In some embodiments, a partial curing of the deposited ink is performed after selective deposition of one layer of ink, each layer of ink, several layers of ink, or all layers of the ink necessary to print the desired 3D article. A “partially cured” ink, for reference purposes herein, is one that can undergo further curing. For example, a partially cured ink is up to about 30% polymerized or cross-linked or up to about 50% polymerized or cross-linked. In some embodiments, a partially cured ink is up to about 60%, up to about 70%, up to about 80%, up to about 90%, or up to about 95% polymerized or cross-linked.

Partial curing of the deposited ink can include irradiating the ink with an electromagnetic radiation source or photocuring the ink (including with curing radiation described hereinabove). Any electromagnetic radiation source not inconsistent with the objectives of the present disclosure may be used, e.g., an electromagnetic radiation source that emits UV, visible or infrared light. For example, in some embodiments, the electromagnetic radiation source can be one that emits light having a wavelength from about 300 nm to about 900 nm, e.g., a Xe arc lamp.

Further, in some embodiments, a post-curing is performed after partially curing is performed. For example, in some cases, post-curing is carried out after selectively depositing all layers of the ink necessary to form a desired 3D article, after partially curing all layers of the ink, or after both of the foregoing steps have been performed. Moreover, in some embodiments, post-curing comprises photocuring. Again, any electromagnetic radiation source not inconsistent with the objectives of the present disclosure may be used for a post-curing step described herein. For example, in some embodiments, the electromagnetic radiation source can be a light source that has a higher energy, a lower energy, or the same energy as the electromagnetic radiation source used for partial curing. In some cases wherein the electromagnetic radiation source used for post-curing has a higher energy (i.e., a shorter wavelength) than that used for partial curing, a Xe arc lamp can be used for partial curing and a Hg lamp can be used for post-curing.

Additionally, after post-curing, in some cases, the deposited layers of ink are at least about 80% polymerized or cross-linked or at least about 85% polymerized or cross-linked. In some embodiments, the deposited layers of ink are at least about 90%, at least about 95%, at least about 98%, or at least about 99% polymerized or cross-linked. In some instances, the deposited layers of ink are about 80-100%, about 80-99%, about 80-95%, about 85-100%, about 85-99%, about 85-95%, about 90-100%, or about 90-99% polymerized or cross-linked.

### B. Vat Polymerization Methods

It is also possible to form a 3D article from an ink described herein using a vat polymerization method, such as an SLA method. Thus, in some cases, a method of printing a 3D article described herein comprises retaining an ink described herein in a fluid state in a container and selectively applying energy (particularly, for instance, curing radiation) to the ink in the container to solidify at least a portion of a fluid layer of the ink, thereby forming a solidified layer that defines a cross-section of the 3D article. Additionally, a method described herein can further comprise raising or lowering the solidified layer of ink to provide a new or second fluid layer of unsolidified ink at the surface of the fluid ink in the container, followed by again selectively applying energy (e.g., the curing radiation) to the ink in the container to solidify at least a portion of the new or second fluid layer of the ink to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying the ink. Moreover, in some instances, the electromagnetic radiation has an average wavelength of 300-900 nm, and in other embodiments the electromagnetic radiation has an average wavelength that is less than 300 nm. In some cases, the curing radiation is provided by a computer controlled laser beam. In addition, in some cases, raising or lowering a solidified layer of ink is carried out using an elevator platform disposed in the container of fluid ink. A method described herein can also comprise planarizing a new layer of fluid ink provided by raising or lowering an elevator platform. Such planarization can be carried out, in some cases, by a wiper or roller.

It is further to be understood that the foregoing process can be repeated a desired number of times to provide the 3D article. For example, in some cases, this process can be repeated “n” number of times, wherein n can be up to about 100,000, up to about 50,000, up to about 10,000, up to about 5000, up to about 1000, or up to about 500. Thus, in some embodiments, a method of printing a 3D article described herein can comprise selectively applying energy (e.g., curing radiation) to an ink in a container to solidify at least a portion of an nth fluid layer of the ink, thereby forming an nth solidified layer that defines an nth cross-section of the 3D article, raising or lowering the nth solidified layer of ink to provide an (n+1)th layer of unsolidified ink at the surface of the fluid ink in the container, selectively applying energy to the (n+1)th layer of ink in the container to solidify at least a portion of the (n+1)th layer of the ink to form an (n+1)th solidified layer that defines an (n+1)th cross-section of the 3D article, raising or lowering the (n+1)th solidified layer of ink to provide an (n+2)th layer of unsolidified ink at the surface of the fluid ink in the container, and continuing to repeat the foregoing steps to form the 3D article. Further, it is to be understood that one or more steps of a method described herein, such as a step of selectively applying energy (e.g., curing radiation) to a layer of ink, can be carried out according to an image of the 3D article in a computer-readable or digital format. General methods of 3D printing using stereolithography are further described, inter alia, in U.S. Pat. Nos. 5,904,889 and 6,558,606.

Performing a printing process described above can provide a printed 3D article from an ink described herein that has a high feature resolution. The “feature resolution” of an article, for reference purposes herein, can be the smallest controllable physical feature size of the article. The feature resolution of an article can be described in terms of a unit of distance such as microns (μm), or in terms of dots per inch (dpi). As understood by one of ordinary skill in the art, a higher feature resolution corresponds to a higher dpi value but a lower distance value in μm. In some cases, an article formed by depositing or solidifying an ink described herein can have a feature resolution of about 500 μm or less, about 200 μm or less, about 100 μm or less, or about 50 μm or less, including at elevated temperatures. In some embodiments, an article has a feature resolution between about 50 μm and about 500 μm, between about 50 μm and about 200 μm, between about 50 μm and about 100 μm, or between about 100 μm and about 200 μm. Correspondingly, in some instances, an article described herein has a feature resolution of at least about 100 dpi, at least about 200 dpi, at least about 250 dpi, at least about 400 dpi, or at least about 500 dpi. In some cases, the feature resolution of an article is between about 100 dpi and about 600 dpi, between about 100 dpi and about 250 dpi, or between about 200 dpi and about 600 dpi.

In a vat polymerization method such as described above, the ink may be partially cured as described in Section IIA above. For example, in some embodiments, selectively applying energy to the ink in the container to solidify at least a portion of a fluid layer of the ink may include partially curing at least a portion of a fluid layer of the ink. In other embodiments, partial curing of at least a portion of a fluid layer of the ink may occur after a first layer of the ink is provided and solidified, before or after a second layer of the ink is provided or solidified, or before or after one, several, or all subsequent layers of the ink are provided or solidified.

Additionally, in some embodiments of a vat polymerization method described herein, after partial curing or after the desired 3D article is formed, post-curing as described in Section IIA above may be performed. The desired 3D article may be, for example, an article that corresponds to the design in a CAD file.

### III. Printed 3D Articles

In another aspect, printed 3D articles are described herein. In some embodiments, a printed 3D article is formed from an ink described herein. Any ink described hereinabove in Section I may be used. For example, in some cases, the ink comprises a composite ink comprising 30-45 wt. % carrier ink and 45-70 wt. % solid powder filler dispersed in the carrier ink, based on the total weight of the composite ink. Further, in some cases, a printed 3D article described herein is formed primarily from a poly(meth)acrylate polymer network including or encapsulating the solid powder filler particles.

Some embodiments of inks for 3D printing are also further illustrated in the following non-limiting Examples.

### Example 1

### HALT Test Method

HALT scores of inks are measured as follows. In general, a highly accelerated life test (HALT) is a method by which a liquid or slurry is tested for changes in the physical properties of that liquid or slurry over time and under different conditions. In the present case, the tested conditions include time and temperature, and the tested property is sedimentation. To conduct the HALT, a known mass (15 g) of ink in the liquid (uncured) state is placed in a container at room temperature (22° C.) or in an oven. The oven is set to a specific temperature (e.g., 50° C. or 65° C.). The container is a 20-mL scintillation glass vial preloaded with 6.5 g+/−0.1 g stainless steel balls (3 mm diameter), which is a sufficient number of balls to cover the bottom of the vial with one layer. The test vials (containing the test ink disposed on the layer of stainless steel balls) are left undisturbed in an upright position at the specific temperature (e.g., 22° C., 50° C., or 65° C.). Sedimentation is measured at certain time points, and the total test period is typically 8 weeks or longer. At each time point, sedimentation is measured as described below. After completion of each sedimentation test, the test vial is returned to its original upright position.

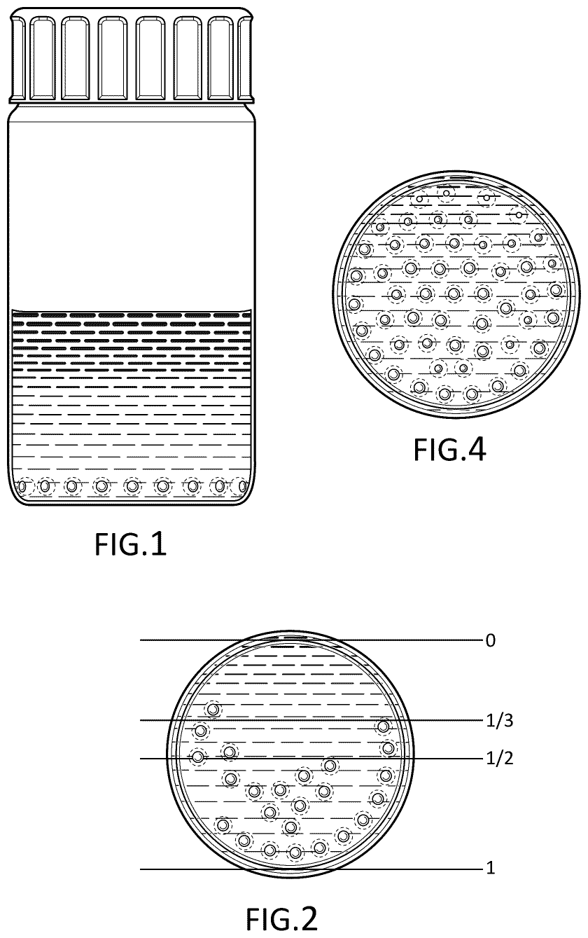

At each time point at which sedimentation is measured, sedimentation of the stainless steel balls is scored by measuring the time it takes for the stainless steel balls (specific gravity 7.99 to 8.00 g/cc) to fall a certain distance inside the vial, after the vial is turned on its side (90 degrees from the upright position). FIG. 1 illustrates a 20-mL vial in an upright position containing a fixed mass (6.5+/−0.1 g) of stainless steel balls on the bottom. A stopwatch is started by a human operator when the vial is laid on its side and gravity begins acting on the stainless steel balls, as illustrated in FIG. 2. The falling of the stainless steels balls inside the vials is visually observed by the human operator. When the stainless steel balls fall a distance equal to one-third of the diameter of the vial (8.5 mm), the human operator stops the timer and records the elapsed time to the closest one second interval.

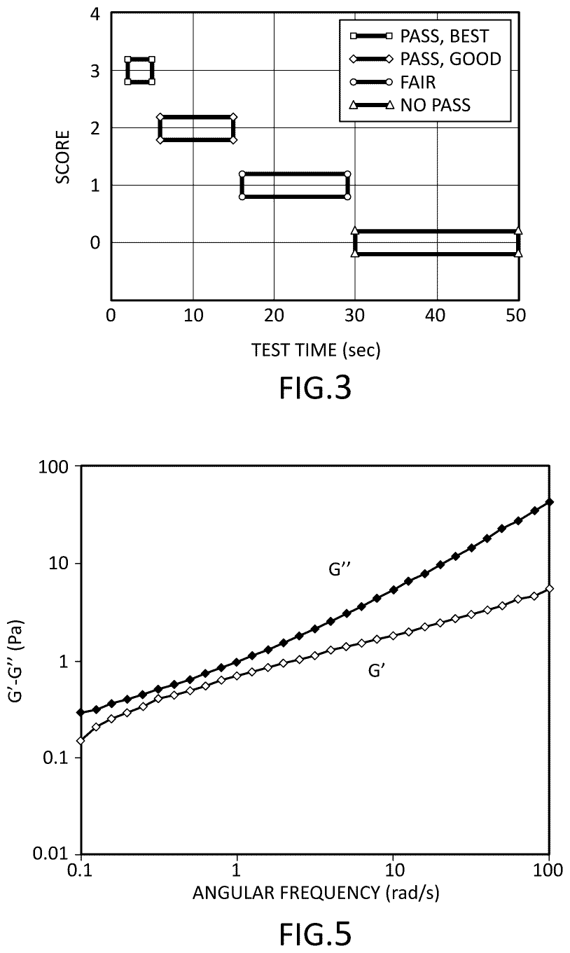

A HALT score is assigned based on the elapsed time. There are four possible scores: 3, 2, 1, and 0. The highest or best score is 3. A score of 3 means the balls fell the quickest, within an elapsed time of 5 seconds or less, as shown in Table 2 below and in FIG. 3.

TABLE 2
HALT Scores.

| HALT Score | Elapsed Time |
|---|---|
| 3 | 5 seconds or less |
| 2 | 6 to 15 seconds |
| 1 | 16 to 30 seconds |
| 0 | greater than 30 seconds |

A HALT score of 2 is associated with a time of 6 to 15 seconds. A HALT score of 1 is assigned to an elapsed time of 16 to 30 seconds, and a HALT score of 0 is assigned to any elapsed time above 30 seconds. A test sample that shows very little or no movement of the stainless steel balls after 30 seconds, as seen in FIG. 4, is an indication of severe sedimentation and the end of the overall HALT evaluation for that sample (no matter at what specific measurement time point this observation occurs).

A HALT score is assigned for each time point at which measurement occurs. As described further herein, a HALT score of at least 2 at a time period of at least 14 days (or 2 weeks) is considered an acceptable result, and a HALT score of 3 is preferred, in some embodiments.

### Example 2

### Viscosity Test Method for Carrier Ink

The viscosity of a carrier or base ink described herein (containing no solid powder filler) is measured using a Brookfield Ametek DVE-LV type viscometer, Model DVEELVTJO, equipped with a Brookfield Ametek Small Sample Adaptor. The environmental condition for testing is controlled with a water jacket of the small sample adaptor which was connected to a Brookfield TC-650 Refrigerated Circulating Bath. The temperature of the test sample is maintained at 30.0° C.±0.5° C. The sample is maintained at approximately 21° C. (laboratory conditions) for at least 1 day before viscosity testing. The Brookfield measurement tools are as follows: size SC4-13R chamber (Diameter 19.05 mm) and size #21 spindle (spindle L, 31.24 mm; spindle D, 16.77 mm; spindle effective L, 35.15 mm). The test ink is poured into a 10-mL disposable syringe instead of being drawn into the syringe, to prevent pre-shearing and bubble formation. After adjustment of the volume of the sample to 7.2 mL, the sample is slowly dispensed onto the inner side of the chamber, ensuring minimal foam/bubble formation. The spindle is slowly inserted into the resin and raised 1-3 mm and held for 5-15 seconds, allowing test ink to flow underneath the spindle. The chamber and spindle are mounted to the viscometer to start testing. The rotation speed (rotations per minute, RPM) is set to the smallest value, and the start time of the experiment is noted. If the % Full Scale range (FSR) of the torque measurement is lower than 75%, the rotation speed (RPM) is increased slowly to reach at least 75% of the Full-Scale range (FSR) and left for steady state measurement. The final viscosity values are reported at 15 minutes of the measurement in centipoise (cPs) units.

### Example 3

### Flow Properties Test Method for Composite Ink

The flow properties of a composite liquid or ink described herein (containing solid powder filler) was measured using an ARES-G2 Rheometers from TA Instruments. The method was developed based on ASTM D4440-15 and adapted for slurry liquids. Parallel plate (round discs) geometry was utilized with 40 mm (diameter), stainless steel bottom and top plates (round discs). The gap size (sample thickness) was kept at 1±0.05 mm and the test temperature was 30.0±0.5° C. Two primary test methods were utilized to evaluate the flow behavior of the samples: (1) steady torsional shear and (2) small amplitude oscillatory shear (SAOS) methods. Steady torsional shear measurements were done in stress growth test setting on the rheometer and 5 different shear rate values (0.01, 0.05, 0.1, 0.5, and 1 s-1) were applied to the sample for a fixed time interval in sequence. The steady state viscosity values for each shear rate were reported and shear viscosity curves (shear viscosity vs shear rate) of the samples were obtained. For the small amplitude oscillatory shear (SAOS) method, strain amplitude sweep and dynamic frequency sweep tests were applied. Strain amplitude sweep tests were applied to ensure that the dynamic frequency sweep tests were performed in linear viscoelastic conditions. The strain values are changed in between 0.1% and 100% strain amplitude at a constant angular frequency value of 5 rad/s and the onset of non-linear strain amplitude value was observed in between 1% and 2% strain amplitude values. Dynamic frequency sweeps tests were applied in the range of 0.1-100 rad/s at 1 or 2% stain amplitude values depending on the onset of nonlinear condition of the samples. The storage (elastic) modulus (G′), loss (viscous) modulus (G″) and tan delta values (G″/G′) were calculated and reported. An example plot of the storage modulus (G′, bottom curve) and the loss modulus (G″, top curve) as a function of angular frequency (rad/s) for a composite ink according to one embodiment described herein is illustrated in FIG. 5, to assist with general understanding. Specifically, FIG. 5 corresponds to Composite Ink 2 from Example 5 below.

### Example 4

### Carrier Inks

Inks according to some embodiments described herein were prepared as follows. Specifically, to prepare various carrier inks, the components of the inks were mixed in a reaction vessel to form specific carrier or base inks (e.g., as shown for Carrier Inks 1-8 in Table 3). The amounts of various components in Table 3 refer to the wt. % of each component of the identified ink, based on the total weight of the ink. For each ink, the appropriate mixture was heated to a temperature with stirring (e.g., 50-70° C.). The heating and stirring were continued until the mixture attained a substantially homogenized state. Next, in some cases, the mixture was allowed to cool to ambient temperature, if the solid powder filler was added later. Alternatively, the solid powder filler could be added to the completed carrier ink before the carrier ink was permitted to cool. Additionally, as described below in Example 5, it is also possible to add the solid powder filler component to all of the carrier ink components, such that the heating, stirring, and/or blending process described above takes place in the presence of all components (including both the filler and the carrier ink components), and the result of the process is a composite ink described herein. In such cases, the composite ink can be allowed to cool, if desired, to a specific temperature such as room temperature after blending of components is complete.

In Table 3, “Mono.” refers to the monomeric curable material component; “Oligo.” refers to the oligomeric curable material component; “PI” refers to the photoinitiator component; “Stab.” refers to the stabilizer component; and “Color.” refers to the colorant component. For Carrier Ink 1 in Table 3, the monomeric curable material component included a mixture of monofunctional (meth)acrylates (67.2 wt. %) and trifunctional (meth)acrylates (11 wt. %). The oligomeric curable material component of Carrier Ink 1 was polymeric/oligomeric urethane acrylate. The photoinitiator was bisacylphosphine oxide (BAPO), the stabilizer was butylated hydroxytolune (BHT), and the colorant was curcumin.

For Carrier Ink 2 in Table 3, the monomeric curable material component included a mixture of monofunctional (meth)acrylates (67.01 wt. %) and trifunctional (meth)acrylates (11.04 wt. %). The oligomeric curable material component of Carrier Ink 2 was oligomeric urethane acrylate. The photoinitiator was Omnirad or Irgacure 819, and the stabilizer was BHT.

For Carrier Ink 3 in Table 3, the monomeric curable material component included a mixture of monofunctional (meth)acrylates (67.06 wt. %) and trifunctional (meth)acrylates (11.04 wt. %). The oligomeric curable material component of Carrier Ink 3 was oligomeric urethane acrylate. The photoinitiator was Omnirad or Irgacure 819, and the stabilizer was BHT.

For Carrier Ink 4 in Table 3, the monomeric curable material component included a combination of monofunctional (meth)acrylates (69.6 wt. %) and trifunctional allyls (11.2 wt. %). The oligomeric curable material component of Carrier Ink 4 was oligomeric urethane dimethacrylate. The photoinitiator was Omnirad or Irgacure 819.

For Carrier Ink 5 in Table 3, the monomeric curable material component included a combination of monofunctional (meth)acrylates (58.8 wt. %) and trifunctional (meth)acrylates (29.4 wt. %). The oligomeric curable material component of Carrier Ink 5 was oligomeric urethane dimethacrylate. The photoinitiator was Omnirad or Irgacure 819.

For Carrier Ink 6 in Table 3, the monomeric curable material component included a combination of monofunctional (meth)acrylates (39.2 wt. %) and trifunctional (meth)acrylates (29.4 wt. %). The oligomeric curable material component of Carrier Ink 6 was oligomeric urethane dimethacrylate. The photoinitiator was Omnirad or Irgacure 819.

For Carrier Ink 7 in Table 3, the monomeric curable material component included a combination of monofunctional (meth)acrylates (69.6 wt. %) and trifunctional (meth)acrylates (11.2 wt. %). The oligomeric curable material component of Carrier Ink 7 was oligomeric urethane dimethacrylate. The photoinitiator was Omnirad or Irgacure 819.

For Carrier Ink 8 in Table 3, the monomeric curable material component included a combination of monofunctional (meth)acrylates (68.9 wt. %) and trifunctional (meth)acrylates (11.1 wt. %). The oligomeric curable material component of Carrier Ink 8 was oligomeric urethane dimethacrylate. The photoinitiator was Omnirad or Irgacure 819.

TABLE 3
Carrier Ink Compositions.

| | Mono. | Oligo. | PI | Stab. | Color. | Total |
|---|---|---|---|---|---|---|
| Carrier Inks | (wt. %) | (wt. %) | (wt. %) | (wt. %) | (wt. %) | (wt. %) |
| Carrier Ink 1 | 78.2 | 19.4 | 0.95 | 1.44 | 0.01 | 100 |
| Carrier Ink 2 | 78.05 | 19.5 | 0.99 | 1.46 | — | 100 |
| Carrier Ink 3 | 78.1 | 19.5 | 0.95 | 1.45 | — | 100 |
| Carrier Ink 4 | 80.8 | 18.2 | 1 | — | — | 100 |
| Carrier Ink 5 | 88.2 | 9.8 | 2 | — | — | 100 |
| Carrier Ink 6 | 68.6 | 29.4 | 2 | — | — | 100 |
| Carrier Ink 7 | 80.8 | 18.2 | 1 | — | — | 100 |
| Carrier Ink 8 | 80 | 18 | 2 | — | — | 100 |

### Example 5

### Composite Inks

Non-limiting examples of composite inks according to some embodiments described herein were prepared as follows. With reference to Table 4, the identified carrier ink was mixed with the identified solid powder filler to provide the composite ink. As noted above, this mixing can be done sequentially or simultaneously. That is, as one option, a carrier ink can be made as described in Example 4 above, and then the solid powder filler (and possibly other components) can subsequently be added to the carrier ink, with mixing, blending, and/or heating. Moreover, in such cases, the carrier ink may still be warm or heated when the solid powder filler component (and possibly other components) is added. Alternatively, as another option, the solid powder filler component (and possibly other components) can be mixed with the carrier ink components, and all components can be stirred, blended, mixed, and/or heated together in essentially one step, to provide the composite ink.

The amounts indicated in Table 4 refer to weight percents, based on the total weight of the composite ink. The “Carrier Ink” column refers to the numbered example carrier inks of Example 4 (such that, for example, “1” in this column refers to Carrier Ink 1 from Example 4). The “Filler” column in Table 4 refers to the numbered example filler of Table 5 (such that, for example, “1” in this column refers to Filler 1 from Table 5).

The balance of components for Composite Inks 2-6 were colorant (1.2 wt. %), dispersant (0.3 wt. %), and deaeration agent (1%). The balance of components for Composite Inks 7-11 were colorant (0.2 wt. %), dispersant (0.3 wt. %), deaerator (0.3%), and additional monomeric methacrylate (0.5 wt. %). The balance of components for Composite Inks 12-15 were colorant (0.6 wt. %), dispersant (1.3 wt. %), deaerator (1%), and stabilizer (0.5 wt. %). The balance of components for Composite Inks 16-20 were anti-foam agent/deaerator (1 wt. %) and stabilizer (0.5 wt. %), with varying amounts of dispersant (0 wt. %, 0.65 wt. %, 1.3 wt. %, 2.6 wt. %, and 5.2 wt. % for Composite Inks 16-20, respectively).

In Table 5, the “Material” column refers to the material from which the solid powder filler particles are formed; the “Surface Func.” column refers to the functional group that is present on the exterior surface of the particle due to surface functionalization as described herein; the “Particle Size” column refers to the D50 particle size in microns; and the “Particle Shape” column refers to the particle shape, based on SEM analysis.

TABLE 4
Composite Ink Compositions.

| | | Carrier Ink | | Filler |
|---|---|---|---|---|
| Composite Inks | Carrier Ink | (wt. %) | Filler | (wt. %) |
| Composite Ink 1 | 1 | 36 | 3 | 64 |
| Composite Ink 2 | 2 | 34.5 | 3 | 63 |
| Composite Ink 3 | 2 | 34.5 | 7 | 63 |
| Composite Ink 4 | 2 | 34.5 | 1 | 63 |
| Composite Ink 5 | 2 | 34.5 | 9 | 63 |
| Composite Ink 6 | 2 | 34.5 | 8 | 63 |
| Composite Ink 7 | 3 | 34.7 | 3 | 64 |
| Composite Ink 8 | 3 | 34.7 | 2 | 64 |
| Composite Ink 9 | 3 | 34.7 | 4 | 64 |
| Composite Ink 10 | 3 | 34.7 | 5 | 64 |
| Composite Ink 11 | 3 | 34.7 | 6 | 64 |
| Composite Ink 12 | 7 | 66.6 | 3 | 30 |
| Composite Ink 13 | 7 | 56.6 | 3 | 40 |
| Composite Ink 14 | 7 | 46.6 | 3 | 50 |
| Composite Ink 15 | 7 | 36.6 | 3 | 60 |
| Composite Ink 16 | 8 | 38.5 | 7 | 60 |
| Composite Ink 17 | 8 | 37.9 | 7 | 60 |
| Composite Ink 18 | 8 | 37.2 | 7 | 60 |
| Composite Ink 19 | 8 | 35.9 | 7 | 60 |
| Composite Ink 20 | 8 | 33.3 | 7 | 60 |

TABLE 5
Solid Powder Fillers.

| | | | Particle Size | Particle |
|---|---|---|---|---|
| Fillers | Material | Surface Func. | (D50, μm) | Shape |
| Filler 1 | SiO₂ | methacrylate | 0.3 | spheres |
| Filler 2 | SiO₂ | none | 0.5 | spheres |
| Filler 3 | SiO₂ | methacrylate | 0.5 | spheres |
| Filler 4 | SiO₂ | phenyl | 0.5 | spheres |
| Filler 5 | SiO₂ | vinyl | 0.5 | spheres |
| Filler 6 | SiO₂ | isocyanate | 0.5 | spheres |
| Filler 7 | SiO₂ | methacrylate | 1.5 | spheres |
| Filler 8 | SiO₂ | methacrylate | 2.7 | spheres |
| Filler 9 | Al₂O₃ | methacrylate | 0.5 | spheres |

As described above, it is to be understood that composite inks described and claimed herein are not limited to only the exact embodiments of this specific Example or other specific Examples. Instead, based on the teachings of the present disclosure, other specific inks can be formulated by those of ordinary skill in the art.

### Example 6

### Performance Data

Various properties of some composite inks described herein were measured. As indicated below, some composite inks exhibited certain structural properties that were preferred over the structural properties of other composite inks. The data for the composite inks presented in this Example were based on cured articles printed from the inks using a Figure 4® additive manufacturing system from 3D Systems, Inc. In Table 6, HALT scores were determined as described in Example 1, at 22° C., 50° C., and 65° C. at 14 days (or longer). Mechanical properties in Table 7 were determined in accordance with ASTM D790 and/or D628 Type IV. In Tables 6 and 7, the “Comp. Ink” column refers to the specific composite ink number from Example 5, Table 4. “HALT” in Table 6 refers to the HALT scores at 22° C., 50° C., and 65° C., respectively (for Comp. Inks 7, 9, 10, and 11), or at 22° C., 60° C., and 70° C., respectively (for Comp. Inks 16-20). In Table 7, “F.S.” refers to the flexural strength; “T.S.” refers to the tensile strength; and “EOB” refers to the elongation at break; “F.M.” refers to flexural modulus; and “E.M.” refers to elastic modulus.

TABLE 6
Performance Parameters of Composite Inks.

| Comp. Ink | HALT |
|---|---|
| 7 | 3, 3, 3 |
| 9 | 2, 1, 0 |
| 10 | 2, 1, 0 |
| 11 | 3, 0, 0 |
| 16 | 3, 3, 3 |
| 17 | 3, 3, 3 |
| 18 | 3, 3, 3 |
| 19 | 3, 3, 3 |
| 20 | 3, 3, 3 |

TABLE 7
Performance Parameters of Composite Inks.

| Comp. | F.S. | T.S. | EOB | F.M. | E.M. |
|---|---|---|---|---|---|
| Ink | (MPa) | (MPa) | (%) | (MPa) | (MPa) |
| 2 | 129 | 79 | 1.6 | 9000 | 9700 |
| 3 | 125 | 80 | 1.3 | 9400 | 10,400 |
| 4 | 130 | 82 | 1.45 | 8800 | 9600 |
| 5 | 90 | 52 | 0.9 | 6600 | 8100 |
| 6 | 115 | 75 | 0.95 | 10,800 | 11,000 |
| 7 | 144 | 87 | 1.57 | 9250 | 10,500 |
| 8 | 50 | 35 | 0.38 | 9200 | 9900 |
| 9 | 50 | 35 | 0.4 | 9050 | 9700 |
| 10 | 110 | 62 | 0.75 | 9450 | 10,500 |
| 11 | 65 | 40 | 0.4 | 8600 | 9600 |
| 12 | 105 | 68 | 2.5 | 4100 | 4900 |
| 13 | 97 | 60 | 2.6 | 4700 | 5300 |
| 14 | 87 | 58 | 1.9 | 5400 | 5700 |
| 15 | 72 | 42 | 1.1 | 6000 | 6000 |

Some additional non-limiting example embodiments are further provided below.

Embodiment 1. A composite ink for use in a three-dimensional printing system comprising:
a carrier ink comprising a curable material; and
a solid powder filler dispersed in the carrier ink,
wherein the composite ink, in an uncured state, has a highly accelerated life testing (HALT) score of at least 2 when tested at 65° C. for at least 14 days, and/or
wherein the composite ink, in an uncured state, has an average loss factor tan δ of less than or equal to 2 over an angular frequency range of 0.5 to 5 rad/s.

Embodiment 2. The composite ink of Embodiment 1, wherein the composite ink has a HALT score of 3 when tested at 65° C. for at least 14 days.

Embodiment 3. The composite ink of Embodiment 1 or Embodiment 2, wherein the composite ink has a shear viscosity of no greater than 5000 cps at 30° C., based on a shear rate of 1.0 (1/s), when measured in accordance with the shear rate sweep procedure of Example 3.

Embodiment 4. The composite ink of Embodiment 1 or Embodiment 2, wherein the composite ink has a shear viscosity of no greater than 3000 cps at 30° C., based on a shear rate of 1.0 (1/s), when measured in accordance with the shear rate sweep procedure of Example 3.

Embodiment 5. The composite ink of Embodiment 1 or Embodiment 2, wherein the composite ink has a shear viscosity of no greater than 2000 cps at 30° C., based on a shear rate of 1.0 (1/s), when measured in accordance with the shear rate sweep procedure of Example 3.

Embodiment 6. The composite ink of Embodiment 1 or Embodiment 2, wherein the composite ink has a shear viscosity of 500-1500 cps at 30° C., based on a shear rate of 1.0 (1/s), when measured in accordance with the shear rate sweep procedure of Example 3.

Embodiment 7. The composite ink of any of the preceding Embodiments, the curable material of the carrier ink comprises one or more monomeric curable materials.

Embodiment 8. The composite ink of Embodiment 7, wherein the one or more monomeric curable materials is present in the carrier ink in an amount of 15-85 wt. %, based on the total weight of the carrier ink.

Embodiment 9. The composite ink of any of the preceding Embodiments, wherein the curable material of the carrier ink comprises one or more oligomeric curable materials.

Embodiment 10. The composite ink of Embodiment 9, wherein the one or more oligomeric curable materials is present in the carrier ink in an amount of 15-85 wt. %, based on the total weight of the carrier ink.

Embodiment 11. The composite ink of any of the preceding Embodiments, wherein the curable material of the carrier ink comprises a combination of one or more monomeric curable materials and one or more oligomeric curable materials.

Embodiment 12. The composite ink of any of the preceding Embodiments, wherein the curable material of the carrier ink comprises one or more acrylate, methacrylate, or vinyl species.

Embodiment 13. The composite ink of any of the preceding Embodiments, wherein the curable material of the carrier ink comprises one or more epoxy species.

Embodiments 14. The composite ink of any of the preceding Embodiments, wherein all or substantially all of the curable material of the carrier ink is curable by free-radical polymerization.

Embodiment 15. The composite ink of any of the preceding Embodiments, wherein the carrier ink further comprises a photoinitiator component.

Embodiment 16. The composite ink of Embodiment 15, wherein the photoinitiator component is present in the carrier ink in an amount of no greater than 5 wt. %.

Embodiment 17. The composite ink of any of the preceding Embodiments, wherein the carrier ink further comprises an inhibitor component.

Embodiment 18. The composite ink of Embodiment 17, wherein the inhibitor component is present in the carrier ink in an amount of no greater than 1 wt. %.

Embodiment 19. The composite ink of any of the preceding Embodiments, wherein the carrier ink has a shear viscosity of no greater than 200 cps at 30° C., based on a shear rate of 1.0 (1/s), when measured in accordance with the shear rate sweep procedure of Example 2.

Embodiment 20. The composite ink of any of the preceding Embodiments, wherein the carrier ink has a shear viscosity of no greater than 150 cps at 30° C., based on a shear rate of 1.0 (1/s), when measured in accordance with the shear rate sweep procedure of Example 2.

Embodiment 21. The composite ink of any of the preceding Embodiments, wherein the carrier ink has a shear viscosity of no greater than 100 cps or no greater than 50 cps at 30° C., based on a shear rate of 1.0 (1/s), when measured in accordance with the shear rate sweep procedure of Example 2.

Embodiment 22. The composite ink of any of the preceding Embodiments, wherein the solid powder filler comprises a SiO₂ powder.

Embodiment 23. The composite ink of Embodiment 22, wherein the solid powder filler comprises amorphous SiO₂.

Embodiment 24. The composite ink of any of the preceding Embodiments, wherein the solid powder filler has an average particle size of 0.1 μm to 5 μm.

Embodiment 25. The composite ink of any of the preceding Embodiments, wherein the solid powder filler has an average particle size of 0.1 μm to 2 μm.

Embodiment 26. The composite ink of any of the preceding Embodiments, wherein the solid powder filler has an average particle size of 0.1 μm to 1 μm.

Embodiment 27. The composite ink of any of the preceding Embodiments, wherein the solid powder filler has an average particle size of 0.1 μm to 0.5 μm.

Embodiment 28. The composite ink of any of the preceding Embodiments, wherein the composite ink comprises no or substantially no solid powder filler having a particle size of less than 100 nm.

Embodiments 29. The composite ink of any of the preceding Embodiments, wherein the solid powder filler has an average particle aspect ratio of 1 to 1.1.

Embodiment 30. The composite ink of any of the preceding Embodiments, wherein the solid powder filler comprises no or substantially no irregularly shaped particles.

Embodiment 31. The composite ink of any of the preceding Embodiments, wherein the solid powder filler has an average BET specific surface area of less than 30 m²/g, less than 20 m²/g, or less than 10 m²/g.

Embodiment 32. The composite ink of any of the preceding Embodiments, wherein:
the solid powder filler has an average particle size of 0.1 μm to 1 μm, 0.1 μm to 3 μm, or 0.1 μm to 5 μm; and
the solid powder filler has an average specific surface area of less than 30 m²/g, less than 20 m²/g, or less than 10 m²/g.

Embodiment 33. The composite ink of any of the preceding Embodiments, wherein the solid powder filler has a functionalized exterior surface.

Embodiment 34. The composite ink of Embodiment 33, wherein the exterior surface of the solid powder filler is functionalized with (meth)acrylate moieties.

Embodiment 35. The composite ink of any of the preceding Embodiments, wherein the solid powder filler is present in an amount of 20-85 wt. %, based on the total weight of the composite ink, or in an amount of 10-75 v. %, based on the total volume of the composite ink.

Embodiment 36. The composite ink of any of the preceding Embodiments, wherein the solid powder filler is present in an amount of 45-70 wt. %, based on the total weight of the composite ink, or in an amount of 25-55 v. %, based on the total volume of the composite ink.

Embodiment 37. The composite ink of any of the preceding Embodiments, wherein the solid powder filler is present in an amount of 55-65 wt. %, based on the total weight of the composite ink, or in an amount of 38-48 v. %, based on the total volume of the composite ink.

Embodiment 38. The composite ink of any of the preceding Embodiments, wherein the carrier ink is present in an amount of 10-80 wt. %, based on the total weight of the composite ink.

Embodiment 39. The composite ink of any of the preceding claims, wherein the carrier ink is present in an amount of 25-55 wt. %, based on the total weight of the composite ink.

Embodiment 40. The composite ink of any of the preceding Embodiment, wherein the carrier ink is present in an amount of 30-45 wt. %, based on the total weight of the composite ink.

Embodiment 41. The composite ink of any of the preceding Embodiments, wherein the composite ink further comprises a dispersant.

Embodiment 42. The composite ink of Embodiment 41, wherein the dispersant is present in an amount of 0.2-5 wt. % compared to the amount of solid powder filler.

Embodiment 43. The composite ink of any of the preceding Embodiments, wherein the composite ink is not a Bingham fluid at 30° C.

Embodiment 44. A method of printing a three-dimensional article comprising:
providing a composite ink according to any of Embodiments 1-43; and
selectively solidifying layers of the composite ink to form the article.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A composite ink for use in a three-dimensional printing system comprising:
a carrier ink comprising a curable material; and
a solid powder filler dispersed in the carrier ink,
wherein the composite ink, in an uncured state, has a highly accelerated life testing (HALT) score of at least 2 when tested at 65° C. for at least 14 days, and/or
wherein the composite ink, in an uncured state, has an average loss factor tan δ of less than or equal to 2 over an angular frequency range of 0.5 to 5 rad/s.

2. The composite ink of claim 1, wherein the composite ink has a HALT score of 3 when tested at 65° C. for at least 14 days.

3. The composite ink of claim 1, wherein the composite ink has a shear viscosity of no greater than 2000 cps at 30° C., based on a shear rate of 1.0 (1/s), when measured in accordance with the shear rate sweep procedure of Example 3.

4. The composite ink of claim 1, wherein:
the curable material of the carrier ink comprises one or more monomeric curable materials; and
the one or more monomeric curable materials is present in the carrier ink in an amount of 15-85 wt. %, based on the total weight of the carrier ink.

5. The composite ink of claim 1, wherein:
the curable material of the carrier ink comprises one or more oligomeric curable materials; and
the one or more oligomeric curable materials is present in the carrier ink in an amount of 15-85 wt. %, based on the total weight of the carrier ink.

6. The composite ink of claim 1, wherein the curable material of the carrier ink comprises a combination of one or more monomeric curable materials and one or more oligomeric curable materials.

7. The composite ink of claim 1, wherein the curable material of the carrier ink comprises one or more acrylate, methacrylate, or vinyl species.

8. The composite ink of claim 1, wherein the curable material of the carrier ink comprises one or more epoxy species.

9. The composite ink of claim 1, wherein all or substantially all of the curable material of the carrier ink is curable by free-radical polymerization.

10. The composite ink of claim 1, wherein:
the carrier ink further comprises a photoinitiator component; and
the photoinitiator component is present in the carrier ink in an amount of no greater than 5 wt. %.

11. The composite ink of claim 1, wherein the carrier ink has a shear viscosity of no greater than 100 cps at 30° C., based on a shear rate of 1.0 (1/s), when measured in accordance with the shear rate sweep procedure of Example 2.

12. The composite ink of claim 1, wherein the solid powder filler comprises a SiO₂ powder.

13. The composite ink of claim 1, wherein:
the solid powder filler has an average particle size of 0.1 μm to 1 μm; and
the composite ink comprises no or substantially no solid powder filler having a particle size of less than 100 nm.

14. The composite ink of claim 1, wherein:
the solid powder filler has an average particle aspect ratio of 1 to 1.1; and
the solid powder filler comprises no or substantially no irregularly shaped particles.

15. The composite ink of claim 1, wherein:
the solid powder filler has an average particle size of 0.1 μm to 1 μm; and
the solid powder filler has an average specific surface area of less than 30 m²/g.

16. The composite ink of claim 1, wherein:
the solid powder filler has a functionalized exterior surface; and
the exterior surface of the solid powder filler is functionalized with (meth)acrylate moieties.

17. The composite ink of claim 1, wherein:
the solid powder filler is present in an amount of 45-70 wt. %, based on the total weight of the composite ink; and
wherein the carrier ink is present in an amount of 25-55 wt. %, based on the total weight of the composite ink.

18. The composite ink of claim 1, wherein:
the composite ink further comprises a dispersant; and
the dispersant is present in an amount of 0.2-5 wt. % compared to the amount of solid powder filler.

19. The composite ink of claim 1, wherein the composite ink is not a Bingham fluid at 30° C.

20. A method of printing a three-dimensional article comprising:
providing a composite ink according to claim 1; and
selectively solidifying layers of the composite ink to form the article.
